(19) United States
(12) Patent Application Publication
(10) Pub. No.: US 2019/0272951 A1
(43) Pub. Date: Sep. 5, 2019

(54) INDUCTOR MOLDED ON AN INSULATIVE PLASTIC BLOCK

(71) Applicant: AJOHO ENTERPRISE CO., LTD., Taipei (TW)

(72) Inventors: Chia-Ping MO, Taipei (TW); You-Chi LIU, Taipei (TW)

(21) Appl. No.: 16/417,034

(22) Filed: May 20, 2019

Related U.S. Application Data
(63) Continuation-in-part of application No. 15/972,814, filed on May 7, 2018.

(30) Foreign Application Priority Data
Nov. 2, 2017 (TW) 106137962

(51) Int. Cl. H01F 41/04; H01F 27/24; H01F 27/28; H01F 27/29; H01F 27/32; H01F 41/02

(52) U.S. Cl. CPC H01F 41/041; H01F 27/24; H01F 41/0206; H01F 27/292; H01F 27/324; H01F 27/2804

(57) ABSTRACT

An inductor includes an insulative plastic block having a block base with a recessed open chamber, a positioning unit including rows of U-shaped plates in the recessed open chamber, and conductors respectively formed on the U-shaped plates by metallization and spaced from one another, each conductor having two opposite leads disposed outside the block base, a magnetic conductive component having a magnetic core with slots cut through opposing top and bottom sides mounted in the recessed open chamber that the U-shaped plates are inserted into the slots of the magnetic core, and a connection carrier including a substrate and a wire array located on the substrate and electrically bonded with the leads; there is a width between each two adjacent U-shaped plates, enabling the conductors to be spaced from one another, the direction and the conductors can be precisely controlled, achieving the effects of high production efficiency and cost effectiveness.

This application is a Continuation-In-Part of co-pending application Ser. No. 15/972,814, filed on May 7, 2018, for which priority is claimed under 35 U.S.C. § 120, the entire contents of which are hereby incorporated by reference.

This application claims the priority benefit of Application number 106137962 filed in Taiwan on Nov. 2, 2017.

### BACKGROUND OF THE INVENTION

### 1. Field of the Invention

The present invention relates to magnetic technologies and more particularly, to an inductor formed on an insulative plastic block using metallization technique, which comprises an insulative plastic block, rows of U-shaped plates of a positioning unit mounted in the insulative plastic block in a staggered manner and conductors respectively formed on the U-shaped plates by metallization, magnetic cores of magnetic conductive components mounted in the insulative plastic block, and a connection carrier with a wire array thereof electrically bonded with the conductors to create with the magnetic cores a magnetic coil loop capable of providing a magnetic induction effect.

### 2. Description of the Related Art

With the rapid growth of electronic technology, active components and passive components are widely used on internal circuit boards of electronic products. Active components (such as microprocessors or IC chips) can perform arithmetic and processing functions alone. However, passive components (such as resistors, capacitors and inductors, etc.) will maintain their resistance or impedance when the applied current or voltage is changed. In application, active components and passive components are used in information, communication and consumer electronic products to achieve electronic loop control subject to matching of circuit characteristics between components.

Further, an inductor generates electromotive force due to changes in current passing through the circuit, thereby resisting changes in current. There are many types of inductors. Inductors often used as electromagnets and transformers are known as coil that can provide high resistance to high frequency. An inductor for use to block higher-frequency alternating current (AC) in an electrical circuit, while passing lower-frequency or direct current (DC) is often referred to as choke or choke ring. Large inductors used with ferromagnetic materials in transformers, motors and generators are called windings. Inductors according to the electromagnetic induction can be divided into self-induction and mutual induction. When the wire turns wound round the magnetic body (such as magnetic core or ferromagnetic material) increases, the inductance will also become larger. The number of wire turns, the area of the wire turns (loop) and the wire material will affect the inductance size.

An inductor typically consists of an insulated wire wound into a coil around a ferromagnetic magnetic core or a core material with a higher magnetic permeability than the air. When the current flowing through the inductor changes, the time-varying magnetic field induces a voltage in the conductor. However, in actual applications, conventional inductors still have drawbacks as follows:

(1) When the insulated wire is wound into a coil around the ferromagnetic core, uneven winding of the coil often occurs due to differences in manual winding distribution, and the stray capacitance on the inductor will be difficult to control, resulting in differences between the noise suppression capabilities of same specification coils. Thus, the exact distance between the coil windings must be controlled. Due to small core volume, the manual winding method takes a lot of man-hours. Further, manual winding is not practical for mass production so that the manufacturing cost cannot be reduced.

(2) In order to obtain a larger amount of inductance, the coil windings will generally be overlapped, however, the insulative layer of the enameled wire can easily be scratched during the winding process. Further, overlapping the coil windings of the insulated wire around the ferromagnetic core will greatly increase the dimension of the inductor, in sequence, the inductor will require a relatively larger circuit board mounting surface to affect the overall circuit layout. When bonding the leads of the coil of the inductor to a circuit board, the large volume of the coil can touch other electronic components on the circuit board, causing coil damage and affecting the elelectrical characteristics and charge and discharge functions of the inductor.

The way of the conventional techniques in which the inductive component is wound around the coil must be improved in both the overall structure and the process. In order to increase production efficiency and reduce costs in response to the demand for production line fixtures and processes, it is the key to research and improvement for those engaged in this industry.

### SUMMARY OF THE INVENTION

The present invention has been accomplished under the circumstances in view. It is therefore the main object of the present invention to provide an inductor formed on an insulative plastic block using metallization technique, which ensures the integrity of the coil circuit, improves the product yield, consistency and reliability and reduces the cost.

To achieve this and other objects of the present invention, an inductor formed on an insulative plastic block using metallization technique comprises an insulative plastic block, a positioning unit and a plurality of conductors. The insulative plastic block comprises a block base that defines therein a recessed open chamber. The positioning unit comprises a plurality of U-shaped plates arranged in rows in the recessed open chamber. The conductors are respectively formed on the U-shaped plates by metallization and spaced from one another, each having two opposite ends thereof respectively terminating in a lead outside the block base. The coil structural design of the conductors formed of a conductive material on the positioning unit of the insulative plastic block by metallization enables the dimension of the inductor to be minimized without increasing the overall height. Since the direction and density of multiple conductors can be precisely controlled according to actual needs, the invention greatly improves the manufacturing quality and yield, achieving the effects of simple structure, ease of installation, high production efficiency and cost effectiveness.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of an inductor formed on an insulative plastic block using metallization technique in accordance with the present invention.

FIG. 2 is an oblique elevational view of a part of the present invention, illustrating conductors formed on the positioning unit of the insulative plastic block.

FIG. 3 is a sectional side view of a part of the present invention, illustrating conductors formed on the positioning unit of the insulative plastic block.

FIG. 4 is a sectional front view of the inductor in accordance with the present invention.

### DETAILED DESCRIPTION OF THE PREFERRED EMBODIMENT

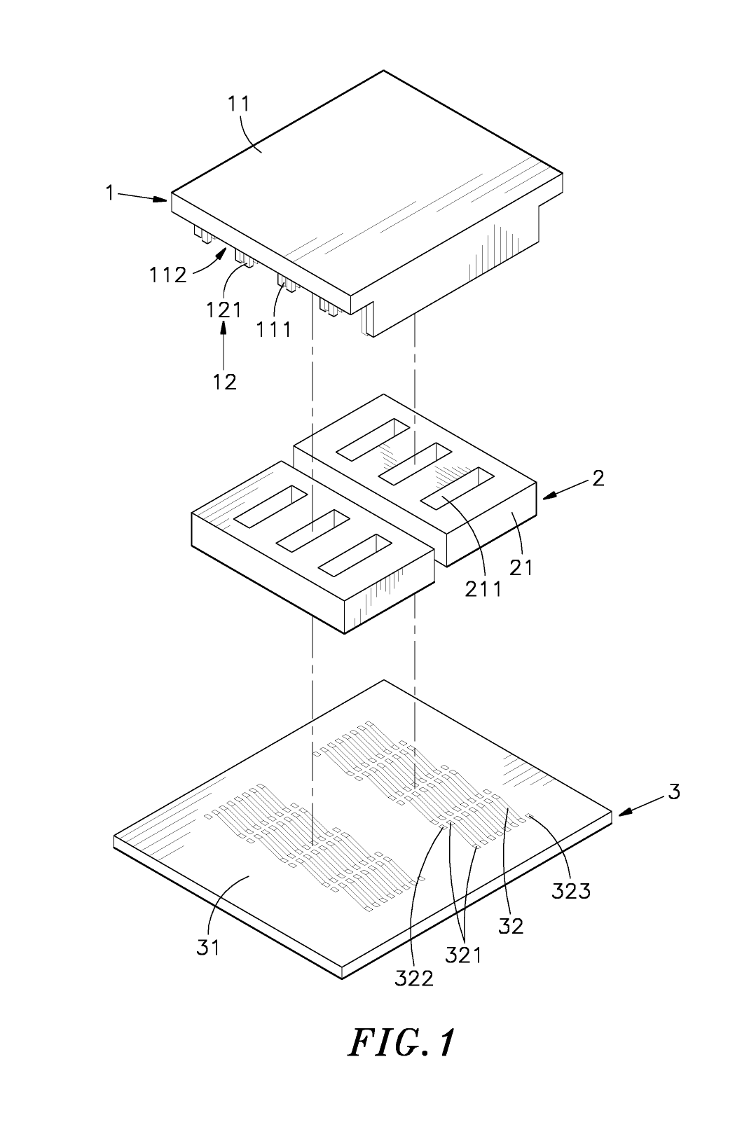

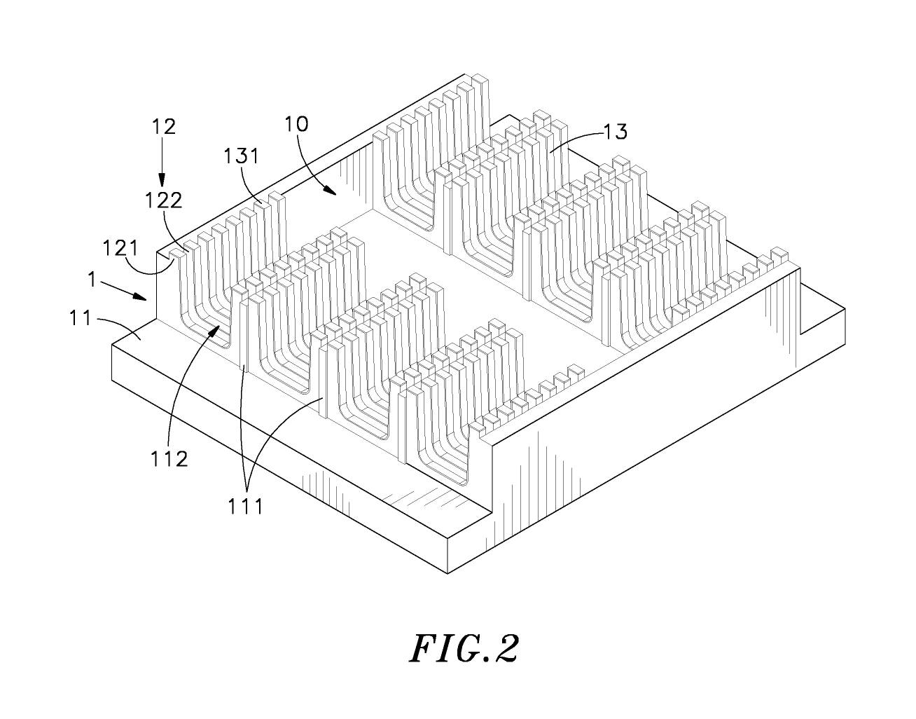

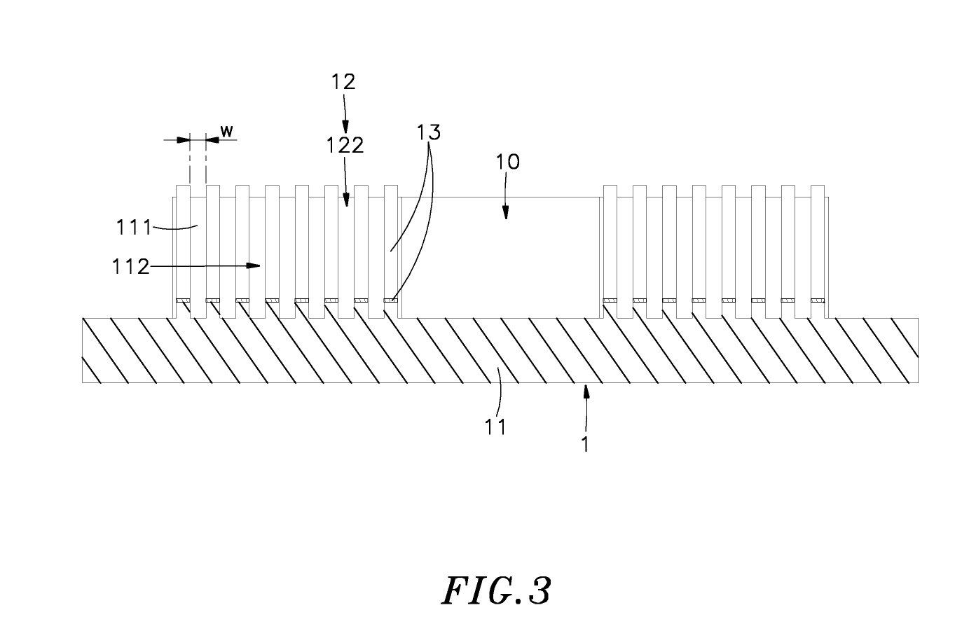

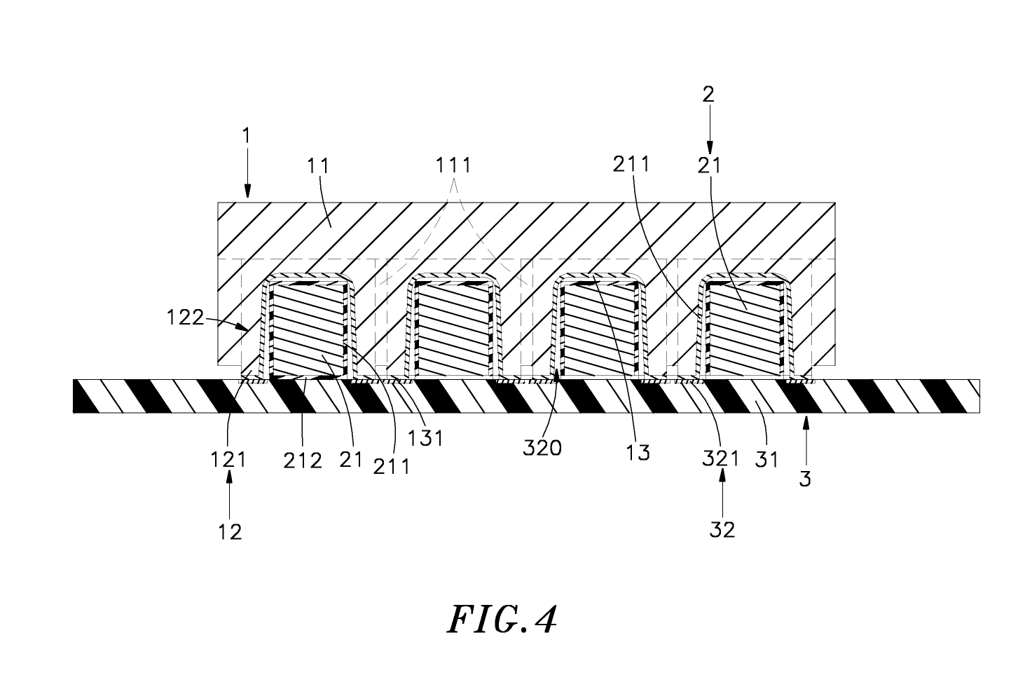

Referring to FIGS. 1-4, an inductor formed on an insulative plastic block using metallization technique in accordance with the present invention is shown. As illustrated, the inductor formed on an insulative plastic block using metallization technique comprises an insulative plastic block 1, a plurality of magnetic conductive components 2 and a connection carrier 3.

The insulative plastic block 1 comprises a block base 11 that is made from a plastic material in one piece by injection molding and defines a recessed open chamber 10 in a top side thereof, a plurality of partition plates 111 mounted in the recessed open chamber 10 and arranged in an array and dividing the recessed open chamber 10 into a plurality of parallel channels 112, a positioning unit 12 mounted in the channels 112, and conductors 13 formed on the positioning unit 12. The positioning unit 12 comprises a plurality of U-shaped plates 121 mounted in the channels 112 with respective opposite ends thereof protruding over the block base 11, and a separation groove 122 defined between each two adjacent U-shaped plates 121. The U-shaped plates 121 are spaced from one another and the separation groove 122 has a width W in a range of 0.5 mm-3 mm between each two adjacent U-shaped plates 121. The conductors 13 are respectively formed of a conductive material on the U-shaped plates 121 by laser activation. These conductors 13 are spaced from one another. Each conductor 13 has two opposite ends thereof respectively terminating in a lead 131. The leads 131 of the conductors 13 are respectively located on the opposite ends of the respective U-shaped plates 121 outside the block base 11 and disposed in a coplanar relationship.

The magnetic conductive components 2 can be made of iron, cobalt, nickel or alloy materials thereof, each comprising a magnetic core 21 in, for example, rectangular shape. The magnetic core 21 has a plurality of slots 211 cut through opposing top and bottom sides thereof, and an insulative layer 212 of an insulating varnish coated on the outer surface thereof.

The connection carrier 3 comprises a substrate 31 selected from, but not limited to, the insulative material group of bakelite, fiberglass, plastic sheet, ceramic and prepregs, and a wire array 32 made of a copper foil and located on a surface of the substrate 31. The wire array 32 comprises a plurality of contact sets 321 each comprising two staggered rows of contacts, an input side 322 electrically connected with a first contact of each contact set 321, and an output side 323 electrically connected with a last contact of each contact set 321.

In installation, put the magnetic cores 21 of the magnetic conductive components 2 in the recessed open chamber 10 in the block base 11 of the insulative plastic block 1 to force the U-shaped plates 121 of the positioning unit 12 into the slots 211 of the magnetic cores 21, enabling one lead 131 of each conductor 13 to be disposed in one slot 211 of one respective magnetic core 21 and the other lead 131 of each conductor 13 to be disposed outside the respective magnetic core 21. At this time, the leads 131 are disposed outside the insulative plastic block 1 and the magnetic cores 21. Thus, the conductors 13 are arranged side by side, in a ring or array, across the magnetic core 21. In this embodiment, the insulative plastic block 1 and the magnetic conductive components 2 are assembled at first. Further, when mounting the magnetic cores 21 in the block base 11, a glue dispensing technique is employed. However, in actual application, the assembly sequence may also be changed according to the manufacturing process or structural design. For example, the magnetic cores 21 of the magnetic conductive components 2 may be set on the connection carrier 3 first, and then assembled and soldered with the insulative plastic block 1. Thus, the insulative plastic block 1, the magnetic conductive components 2 and the connection carrier 3 are assembled to form an inductor.

In the present preferred embodiment, set the insulative plastic block 1 and the magnetic conductive components 2 on the substrate 31 of the connection carrier 3 to abut the leads 131 of the conductors 13 at the contact sets 321 of the wire array 32 and the solder material (such as solder paste, solder balls or conductive adhesive) in forming a coplane, and then employ surface-mount technology (SMT) to bond the leads 131 of the conductors 13 to the contact sets 321 of the wire array 32, thereby forming the desired inductor (transformer or other inductance component). When an electric current is conducted to the input side 322 of the wire array 32, the electric current goes through an induction area 320 between the contact sets 321 and the conductors 13 to an external circuit via the output side 323. Subject to the magnetic induction effect of the magnetic coil loop formed by the magnetic cores 21 of the magnetic conductive components 2, the inductor of the present invention provides stable inductive effect and rectifying characteristic. The coil structural design of the conductors 13 formed of a conductive material on the positioning unit 12 of the insulative plastic block 1 by metallization enables the dimension of the inductor to be minimized without increasing the overall height. Since the direction and density of multiple conductors 13 can be precisely controlled according to actual needs, the inductors can have the same or similar electrical characteristics to improve the manufacturing quality and yield, achieving the effects of simple structure, ease of installation, high production efficiency and cost effectiveness.

Further, as described above, the U-shaped plates 121 of the positioning unit 12 are mounted in the channels 112 of the block base 11 of the insulative plastic block 1 with the respective opposite ends thereof protruded over the block base 11. Further, the surface of the U-shaped plates 121 of the positioning unit 12 is processed by laser activation, and then the conductors 13 are formed of a conductive material on the U-shaped plates 121 of the positioning unit 12 by chemical metallization. The leads 131 of the conductors 13 are respectively located on the opposite ends of the respective U-shaped plates 121 outside the block base 11 and respectively bonded with the contact sets 321 of the wire array 32 of the connection carrier 3 to create magnetic coil loop capable of providing a magnetic induction effect.

Further, the conductors 13 are formed of a conductive material on the U-shaped plate 121 in the channels 112 of the block base 11 of the insulative plastic block 1 by laser direct structuring (LDS). The laser direct structuring (LDS) to form the conductors 13 on the U-shaped plate 121 is a laser technique in 3D-MID (Three-dimensional Molded Interconnect Device) technology. First, a laser activation process is performed, and the surface tin anti-etch resist on each of the U-shaped plates 121 is burned by the activation of the laser beam to generate a physical chemical reaction to form a metal core, and thus, a rough surface is formed on each of the U-shaped plate 121. The conductive material (which may be copper, zinc or nickel or its alloy material.) is attached to the rough surface of each of the odd-numbered rows of U-shaped plate 121 during metallization to form a metal layer. Metallization is then employed to the metal layer on each of the U-shaped plate 121 to form a circuit (copper or nickel) of about 5 to 8 μm (micrometer) on the metal layer of the conductive material, i.e., to form the aforesaid conductors 13 on the U-shaped plate 121 that are spaced from one another without contact.

As described above, the insulative plastic block 1 comprises a block base 11 made from a plastic material in one piece by injection molding and defines a recessed open chamber 10 in the top side thereof, a plurality of partition plates 111 mounted in the recessed open chamber 10 and arranged in an array and dividing the recessed open chamber 10 into a plurality of parallel channels 112, a positioning unit 12 mounted in the channels 112, and conductors 13 formed on the positioning unit 12. The positioning unit 12 comprises a plurality of U-shaped plates 121 mounted in the channels 112 with respective opposite ends thereof protruding over the block base 11, and a separation groove 122 defined between each two adjacent U-shaped plates 121; the conductors 13 are respectively formed of a conductive material on the U-shaped plates 121 by laser activation and chemical metallization. During laser direct structuring, a part of the conductive material formed on the U-shaped plates 121 is removed at a predetermined interval (for example, 0.5 mm, 1 mm, 1.5 mm, 2 mm, 2.5 mm or 3 mm). After formation, the conductors 13 are spaced from one another by a predetermined gap, and the leads 131 of the conductors 13 are respectively located on the opposite ends of the respective U-shaped plates 121 outside the block base 11.

In general, the U-shaped plates 121 of the positioning unit 12 are arranged in the block base 11 of the insulative plastic block 1 in an array; the conductors 13 are respectively formed of a conductive material on the respective U-shaped plates 121 by laser activation and metallization; the magnetic cores 21 of the magnetic conductive components 2 are set in the recessed open chamber 10 in the block base 11 of the insulative plastic block 1 with the U-shaped plates 121 of the positioning unit 12 inserted into the slots 211 of the magnetic cores 21 to keep one lead 131 of each conductor 13 in one slot 211 of one respective magnetic core 21 and the other lead 131 of each conductor 13 outside the respective magnetic core 21, enabling the leads 131 to be disposed outside the insulative plastic block 1 and the magnetic cores 21 and bonded to the wire array 32 of the connection carrier 3 to create a magnetic coil loop capable of providing a magnetic induction effect. There is a width W between each two adjacent U-shaped plates 121, enabling the conductors to be spaced from one another. The direction and density of the multiple conductors 13 can be precisely controlled according to actual needs, ensuring the quality and yield of the manufacturing, thereby achieving the advantages of simple structure, improved production efficiency and cost saving.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An inductor formed on an insulative plastic block using metallization technique, comprising:
an insulative plastic block comprising a block base, said block base defining therein a recessed open chamber;
a positioning unit mounted in said recessed open chamber, said positioning unit comprising a plurality of U-shaped plates arranged in rows in said recessed open chamber and a separation groove defined between each two adjacent said U-shaped plates;
a plurality of conductors respectively formed on said U-shaped plates by metallization and spaced from one another, each said conductor having two opposite ends thereof respectively terminating in a lead outside said block base;
a magnetic conductive component comprising a magnetic core, said magnetic core having a plurality of slots cut through opposing top and bottom sides thereof, said magnetic core being mounted in said recessed open chamber of said block base in such a manner that said U-shaped plates of said positioning unit are inserted into said slots of said magnetic core to keep one lead of each said conductor in one said slot of said magnetic core and the other said lead of each said conductor outside said magnetic core so that said leads of said conductors are respectively located on respective opposite ends of the respective said U-shaped plates outside said block base; and
a connection carrier comprising a substrate and a wire array located on said substrate and electrically bonded with said leads of said conductors.

2. The inductor as claimed in claim 1, wherein said insulative plastic block further comprises a plurality of partition plates mounted in said recessed open chamber and arranged in an array and dividing said recessed open chamber into a plurality of parallel channels; said U-shaped plates are respectively mounted in said channels with respective opposite ends thereof protruding over said block base; said conductors are respectively formed on said U-shaped plates and spaced from one another by said separation grooves with the respective leads thereof respectively disposed outside said block base.

3. The inductor as claimed in claim 2, wherein said leads of said conductors are respectively located on the respective opposite ends of the respective said U-shaped plates outside said block base in a coplanar relationship.

4. The inductor as claimed in claim 3, wherein said wire array comprises a plurality of contact sets, each said contact set comprising a plurality of contacts respectively bonded to said leads to create a magnetic coil loop.

5. The inductor as claimed in claim 4, wherein said leads of said conductors are respectively abutted at said contact sets of said wire array in a coplanar manner and bonded thereto using surface-mount technology.

6. The inductor as claimed in claim 1, wherein said separation grooves have a width in a range of 0.5 mm-3 mm.

7. The inductor as claimed in claim 1, wherein said conductors are respectively formed of a conductive material on said U-shaped plates by laser activation and chemical metallization.

8. The inductor as claimed in claim 1, wherein said conductors are respectively formed of a conductive material on said U-shaped plates by laser direct structuring technology, a part of conductive materials formed on said U-shaped plates is removed at a predetermined interval; after formation, said conductors are spaced from one another by a predetermined gap, and said leads of said conductors are respectively located on opposite ends of said respective U-shaped plates.

9. The inductor as claimed in claim 1, wherein said magnetic core has an insulative layer of an insulating varnish coated on an outer surface thereof.
